(19) United States
(12) Patent Application Publication
(10) Pub. No.: US 2026/0194423 A1
(43) Pub. Date: Jul. 9, 2026

(54) DETECTOR INLET APPARATUS AND METHOD

(71) Applicant: SMITHS DETECTION-WATFORD LIMITED, Hemel Hempstead (GB)

(72) Inventors: Jonathan Richard ATKINSON, Hemel Hempstead (GB); Ben IRWIN, Hemel Hempstead (GB)

(21) Appl. No.: 19/132,528

(22) PCT Filed: Nov. 28, 2023
(86) PCT No.: PCT/GB2023/053080

§ 371 Date: May 23, 2025

(30) Foreign Application Priority Data
Nov. 29, 2022 (GB) 2217953.5

(51) Int. Cl. G01N 1/22; G01N 27/622; H01J 49/04

(52) U.S. Cl. CPC G01N 1/2247; G01N 27/622; H01J 49/0422

(57) ABSTRACT

An inlet apparatus for a detection system, and a method for controlling power consumption in a detection system, are provided. An inlet apparatus comprises an inlet (102) for receiving a flow of air (108) to be tested, the inlet comprising a heater (106) configured to heat the flow of air to vaporise an aerosol carried by the air for sampling by the analytical apparatus (120). A flow provider (114) is configured to draw the flow of air through the inlet past the heater for sampling by the analytical apparatus, and a controller (104) is configured to control operation of the heater and the flow provider to reduce a flow rate of the air past the heater to reduce cooling of the heater before increasing power to the heater to vaporise aerosols, and to control the flow provider to provide aerosols vaporised by the heater for sampling by the analytical apparatus.

The present disclosure relates to detection methods and inlet apparatus for detectors, and more particularly to methods and inlet apparatus for obtaining samples for detectors, still more particularly to methods and inlet apparatus for providing vaporised aerosols to a detector. These methods and apparatus may find particular application in spectrometry, for example ion mobility spectrometry and mass spectrometry.

Some detectors, for example some types of ion mobility spectrometers, operate by “inhaling” a stream of gaseous fluid, such as air, into a detector inlet and sampling that air with an analytical apparatus to detect substances of interest. That inhaled stream of air can be sampled from the detector inlet using a sampling port such as a pinhole, capillary or membrane inlet.

Some analytical apparatus and particularly some ion mobility spectrometers are adapted for the analysis of vapours, and of gases. Such analytical apparatus may be configured to detect substances of interest, such as narcotics, explosives, and chemical warfare agents. Detection sensitivity, and the reliability of such detectors, may therefore be a significant issue. Some substances of interest may comprise aerosols. By contrast with a vapour or gas, an aerosol comprises fine particles of solid or liquid suspended in a gas. Where the substance has a low vapour pressure, an ion mobility spectrometer may be unable to detect particles of that substance in an aerosol without vaporisation of the aerosol.

Often, handheld, or portable devices may be needed for example for use by military and security personnel, which may require reduced size, weight and complexity compared to other detectors. In general these devices are battery powered and it is desired to extend their battery life.

Aspects and embodiments of the present disclosure aim to address the above technical problems.

### SUMMARY

Embodiments of the disclosure relate to detector inlets for providing samples to an analytical apparatus for detecting a substance of interest. Detectors such as mass spectrometers and ion mobility spectrometers may be configured to ionise a vapour, and then to analyse the ions generated from that vapour to detect substances of interest. Such detectors may be configured to inhale a flow of gaseous fluid from an environment to be tested, and then to take samples from this flow. The samples can then be tested to detect the presence of substances of interest. The gaseous fluid may comprise gas, such as air, vapour and aerosols, for example solid or liquid particles suspended in the gaseous fluid.

An analytical apparatus configured to analyse vapour samples can analyse vapours present in the environment being sampled from directly. However, aerosols in the environment may need to be vaporised by heating an aerosol-containing flow of air to facilitate satisfactory analysis of the vaporised aerosol. A heater can be placed in the path of a sample drawn into an inlet of the detector to heat the sample to vaporise aerosols. However, by drawing a flow of air for sampling past the heater, the heater itself is cooled by the passing flow. Due to the cooling effect of the air flow, either significant power is required in order to bring the heater up to the required temperature for vaporising aerosols, or aerosol vaporisation is reduced together with detection sensitivity for aerosols.

Embodiments of the disclosure aim to address such problems by controlling heating and flow through a detector inlet to reduce power requirements and allow efficient heating to levels that can provide the desired level of aerosol vaporisation. In particular, by reducing the flow rate of air past the heater before increasing power to the heater, the cooling effect of the air passing the heater can be reduced while the heater is brought up to temperature for vaporising aerosols. Thus, for a particular power provided to the heater, by reducing the flow past the heater the temperature of the heater can be higher. In this way, the power required for vaporising aerosols may be reduced or, for a given power output, the temperature of the heater may be higher and provide an increase in vaporisation and can provide increased sensitivity for detecting non-volatile aerosols. In addition, at lower flow rates, the residence time of a portion of the flow around the heater is higher, more efficiently heating air and carried aerosols close to the heater when the flow is reduced.

Aspects of the disclosure are set out in the independent claims and optional features are set out in the dependent claims. Aspects of the disclosure may be provided in conjunction with each other, and features of one aspect may be applied to other aspects.

In an aspect there is provided an inlet apparatus for a detection system, the apparatus comprising: an inlet for receiving a flow of air to be tested, the inlet comprising a heater configured to heat the flow of air to vaporise an aerosol carried by the air for sampling by the analytical apparatus; a flow provider configured to draw the flow of air through the inlet past the heater for sampling by the analytical apparatus; and a controller configured to control operation of the heater and the flow provider to reduce a flow rate of the air past the heater to reduce cooling of the heater before increasing power to the heater to vaporise aerosols, and to control the flow provider to provide aerosols vaporised by the heater for sampling by the analytical apparatus.

The inlet apparatus may be configured for providing vapours present in the air drawn into the inlet to the analytical apparatus as well as vaporised aerosols. For example, the controller may be configured to operate the apparatus to detect vapours and aerosols by drawing a first flow of air into the inlet when the heater is off and providing the first flow of air for sampling by the analytical apparatus before reducing the flow rate of the air past the heater. As will be appreciated, while the first flow of air may be drawn into the inlet when the heater is off, in some embodiments the heater may alternatively be operated but at a lower power than that used to vaporise aerosols (for example to reduce deposition of substances in the inlet), and the power subsequently increased to vaporise aerosols after the flow is reduced. The analytical apparatus can be configured to obtain samples from the first flow of air for detecting vapours in the first flow of air. In this way, relatively volatile vapours that do not require heating in the inlet may be provided to the analytical apparatus prior to powering the heater to vaporise aerosols for detection. The sensitivity of the detector for detecting vapours may in some instances be degraded when the vapour sample is heated in the inlet of the detector. Therefore, it may be desirable to sample vapours drawn into the inlet without providing power to the heater. Drawing this air flow into the inlet past the heater will, however, cool the heater as it passes and lead to increased power consumption when bringing the heater to the required temperature when subject to the flow. Thus, by sampling vapours and then reducing the flow before increasing power to the heater, vapours can be effectively sampled in addition to aerosols whilst reducing power requirements of the apparatus.

In order to provide aerosols for detection, the apparatus may be configured to draw a flow of air into the inlet after power is increased to the heater to vaporise aerosols in the flow that are drawn past the heater. Thus, after increasing power to the heater while the flow rate is reduced, the controller may be configured to control the apparatus to draw a second flow of air into the inlet past the heater to vaporise aerosols in the second flow of air and to provide the vaporised aerosols for sampling by the analytical apparatus. Thus, the second flow of air may comprise a sample drawn from outside of the inlet, or from the inlet upstream of the heater, that is drawn past the heater to vaporise aerosols after the heater reaches the required temperature. The analytical apparatus can be configured to obtain samples of vaporised aerosols from the second flow of air for detecting aerosols in the second flow of air.

In some instances, the vaporised aerosols provided to the analytical apparatus for sampling may comprise aerosols present in the vicinity of the heater that are vaporised during the time in which the heater is raised to the required temperature. For example, where the flow is stopped while the heater heats to the required temperature, aerosols near the heater when the flow is stopped may be vaporised and provided to the analytical apparatus when the flow is restored.

Providing vaporised aerosols for sampling by the analytical apparatus suitably comprises providing a flow through the inlet to carry the vaporised aerosols from the heater to the analytical apparatus for sampling (for example controlling the flow provider to provide said flow). Providing the vaporised aerosols for sampling by the analytical apparatus may comprise operating the flow provider to increase the flow rate through the inlet.

In some embodiments, reducing a flow rate of the air past the heater comprises providing a reduced flow rate, and providing the vaporised aerosols for sampling by the analytical apparatus comprises maintaining the reduced flow rate to transport the vaporised aerosols from the heater to the analytical apparatus (for example to a sampling port downstream of the heater through which the analytical apparatus obtains samples from the inlet).

Reducing a flow rate of the air past the heater may in some embodiments comprise stopping the flow provider from providing flow through the inlet. After the heater is powered to provide the desired temperature the flow provider can then be operated to increase the flow rate through the inlet to provide vaporised aerosols for sampling by the analytical apparatus. As described, depending on the timing of sampling by the analytical apparatus, the vaporised aerosols that are sampled may be aerosols drawn into the inlet after the flow is increased, or may be aerosols already present in the inlet when the heater is turned on.

The controller may be configured to control the flow provider to provide the vaporised aerosols to the analytical apparatus after the heater reaches a threshold temperature and/or after a fixed time delay after the heater is turned on. The temperature of the heater may be measured or may suitably be inferred based on the power provided to the heater and/or the time since the heater was turned on for a particular flow rate of air through the inlet. The timing of providing vaporised aerosols for sampling may be based on a time delay after the heater is powered to allow the heater to reach the required temperature. In some instances, the timing may be varied based on the ambient conditions in which the detector is being used. For example, depending on the ambient temperature, the time delay before sampling may in some cases be adjusted based on a known relationship between the time to bring the heater to temperature and the ambient temperature.

As described, the inlet comprises the heater. The heater may be arranged within the inlet or at least partially within it, for example at an entrance to the inlet. In some such examples one or more internal walls of the inlet may comprise the heater. The heater may comprise a conductor, such as a wire which may be arranged to be heated by resistive heating. The wire may comprise metal. The heater may be arranged as a grid or mesh to provide an obstacle in the inlet so that air flowing through the inlet flows through or around the heater. The heater preferably comprises wire arranged in the inlet in the path of the flow of air so that the flow of air must pass the wire to reach the analytical apparatus.

In embodiments, the heater may comprise only an array of wires, for example parallel wires or an array of wires that follow a curved or winding path (e.g. a sinuous path) across the inlet. In preferred embodiments, the heater may be configured to permit flow through the inlet to pass the heater whilst minimising capture of aerosols and vapours on the heater. The heater may comprise elongate conductors, such as resistively heated wire, arranged across the inlet in the path of flow through the inlet (e.g. extending across the inlet perpendicular to the direction of flow through the inlet). The heater may comprise an array of elongate conductors arranged across the inlet, for example an array of elongate conductors that may be arranged in a plane perpendicular to the direction of flow through the inlet. The thickness of the conductors (e.g. wires) and the gaps between conductors may be selected so as to minimise capture of aerosols on the heater. The heater may comprise more than one array of conductors, such as more than one array of conductors arranged in corresponding planes offset from each other in the flow direction. In other embodiments, the heater may comprise a knitted structure, such as a wad or tangle of wire. One example of such a structure comprises a knitted mesh of wire such as Knitmesh®.

The heater structure may be arranged so that the wire occupies less than 80% of its volume, in some examples less than 60%, in some examples less than 40%, in some examples less than 20% of the volume is occupied by wire, and the remaining volume may be occupied by air spaces through which air to be heated can flow. In an embodiment the structure is at least 60% air by volume, and in some embodiments the structure is approximately 70% air by volume. The use of lower densities may improve the efficiency of the apparatus, and the sensitivity achieved by heating the airflow. The heater may provide a constriction in the second sampling pathway, or it may be arranged around a constriction in the path of the second flow of air. In some examples the heater may comprise an infra-red source, such as an infra-red lamp or LED, or an infra-red laser. In some examples the heater may comprise a jet, or a plurality of jets, of hot air injected into the second flow of air in the second sampling pathway before the flow of air is provided to the analytical apparatus for sampling.

The heater may be configured to heat the flow of air to a temperature of at least 150° C. to vaporise aerosols, for example at least 200° C., and/or wherein the heater is configured to heat the flow of air to a temperature of no more than 300° C., for example no more than 250° C. Thus, the heater may be configured to heat the flow of air to a temperature of from 150° C. to 300° C., such as from 200° C. to 250° C.

The cooling effect of the flow through the inlet past the heater will depend on the flow rate or velocity of the flow. The flow velocity through the inlet past the heater prior to reducing the flow rate may be at least 0.4 m/s, such as at least 0.6 m/s. The flow velocity through the inlet past the heater when the heater is turned on is preferably less than 0.4 m/s, such as less than 0.3 m/s. The flow velocity for providing the vaporised aerosols for sampling by the analytical apparatus (e.g. for carrying the vaporised aerosols from the heater to the analytical apparatus) is preferably at least 0.17 m/s, such as at least 0.25 m/s.

The volumetric flow rate through the inlet will vary based on the cross-sectional area of the inlet. In embodiments, the flow rate through the inlet past the heater prior to reducing the flow rate may be at least 400 ml/min, such as at least 600 ml/min, for example at least 800 ml/min. In some preferred embodiments, the flow rate through the inlet prior to reducing the flow rate may be from 800 to 1200 ml/min, such as about 1000 ml/min or 1000 ml/min or more. The flow velocity through the inlet past the heater when the heater is turned on is preferably less than 400 ml/min, such as less than 300 ml/min. The flow velocity for providing the vaporised aerosols for sampling by the analytical apparatus (e.g. for carrying the vaporised aerosols from the heater to the analytical apparatus) is preferably at least 200 ml/min, such as at least 300 ml/min.

As described, the flow velocity/rate for providing the vaporised aerosols for sampling by the analytical apparatus may correspond to the reduced flow when the heater is turned on, or may be higher, such as corresponding to the flow velocity/rate prior to reducing the flow rate.

The inlet may suitably comprise one or more sampling ports through which the analytical apparatus can be configured to obtain samples from the inlet. For example, the one or more sampling ports may be independently selected from a pinhole inlet, a capillary inlet or a membrane inlet. The analytical apparatus may be configured to obtain samples from the inlet in any suitable way, for example by pulsing a sampler (such as a pump) to draw samples from the inlet through the one or more sampling ports.

The inlet apparatus can be configured to provide a flow of air through the inlet past the heater and then past the one or more sampling ports, for example to an exhaust outlet. Thus, the inlet may comprise an opening for receiving the flow of air to be sampled, where the apparatus is configured to draw the flow of air from the opening, past the heater, then past the one or more sampling ports to the exhaust outlet. The flow provider is suitably disposed downstream of the one or more sampling ports to draw flow through the inlet past the heater then past the one or more sampling ports.

In some instances, the apparatus may be used in the presence of dust and grit and other particulate matter. Such particulates may obstruct or otherwise damage or contaminate the detector. The inlet apparatus may be configured to remove particulates from the flow upstream of the inlet whilst carrying vapours and aerosols to the inlet, for example by providing a circuitous flow path from an opening to the ambient atmosphere outside a detector to the inlet that prevents or reduces the proportion of particulates arriving at the inlet. In embodiments, the detector is configured so that the flow provider draws a flow of air to be sampled past one or more sampling ports of the analytical apparatus to permit sampling of vapour in the flow whilst drawing particulates present in the flow past the one or more sampling ports without entering the one or more sampling ports. Whilst the analytical apparatus is configured to sample vapours, some particulates or aerosols may nonetheless enter the one or more sampling ports, however the one or more sampling ports may be arranged to reduce the proportion of particulates or aerosols drawn through the sampling ports when a vapour is sampled. For example, the one or more sampling ports may be configured to draw samples into the analytical apparatus in an orthogonal direction to the direction of bulk flow through the inlet to reduce particulates entering or blocking the sampling ports. The inlet may suitably comprise a sampling volume from which the one or more sampling ports draw samples for analysis by the analytical apparatus. For example, the sampling volume may be a volume of the inlet adjacent to the one or more sampling ports. In embodiments, the inlet may comprise one or more flow directors configured to alter the distribution of particulates within the sampling volume to increase the proportion of particulates that pass the sampling port without being drawn into the sampling port. For example, a flow director may comprise a change in cross-section of the inlet comprising the sampling volume or a change of direction of flow within the inlet to provide a volume adjacent the sampling port having a reduced proportion of particulates present. For example, a flow director may protrude from a wall of the inlet, where a sampling port is arranged on a wall of the inlet downstream of the flow director. Alternatively, a sampling port may be arranged on the inside of a bend in the inlet, or at the centre of a circulatory flow within the inlet such that centrifugal effects reduce the proportion of particulates in a region adjacent the sampling port.

A further aspect provides a detector comprising an inlet apparatus as described elsewhere herein and an analytical apparatus configured to obtain samples from the inlet for detecting a substance of interest. It will be appreciated that any component or control of the detector may suitable be as described elsewhere herein in relation to the inlet apparatus.

The controller may be configured to synchronise operation of analytical apparatus with operation of the flow provider and/or the heater to obtain samples of the vaporised aerosol provided from the heater to the analytical apparatus by the flow provider.

The analytical apparatus may be configured, based on the timing of when samples are taken from the inlet, to sample vaporised aerosols that were drawn into the inlet after the heater is heated to temperature, or may be configured to sample vaporised aerosols that were adjacent the heater when the heater is turned on. For example, in embodiments where the flow is stopped or sufficiently low when the heater is turned on, the heater may vaporise aerosols present adjacent the heater while the heater heats to the desired temperature. Alternatively or additionally, the timing of sampling by the analytical apparatus may be delayed so that aerosols drawn into the inlet after the heater has reached the desired temperature are carried past the heater and vaporised. Subsequent flow through the inlet, such as an increased flow, can then carry the vaporised aerosols through the inlet for sampling by the analytical apparatus. It will be appreciated that the timing of sampling through one or more sampling ports to the analytical apparatus, as well as the flow speed will determine whether vaporised aerosols that are sampled were drawn from outside the inlet past the heater after increasing the heater temperature, or were present when the heater was turned on.

The detector is preferably a portable detector comprising a portable power supply, for example a hand-held detector. As will be appreciated, the power savings that may be obtained by reducing flow past the heater as described herein may be particularly beneficial where a portable power supply, which may have limited capacity, is used. A portable power source may comprise a battery, a fuel cell, a capacitor, or any other portable source of electrical power suitable for providing electrical power to the detector.

The detector may suitably be configured to draw the flow of air into the inlet from an ambient environment in which the detector is situated. For example, the detector may be configured to detect substances of interest in the air of the ambient environment in which the detector is operated (rather than drawing a flow to be sampled from another apparatus such as a chromatography apparatus or a pre-collected sample).

The analytical apparatus may comprise any suitable analyser for detecting a substance of interest in vapour form. The analytical apparatus may comprise at least one of an ion mobility spectrometer (IMS), a differential mobility spectrometer (DMS), a mass spectrometer (MS), a chromatography apparatus (for example a gas chromatography system) and an optical spectrometer (for example an infrared spectrometer or a Raman spectrometer). In embodiments, the analytical apparatus may comprise an ion mobility spectrometer, a mass spectrometer, or a combined IMS-MS. An IMS may comprise a positive IMS and/or a negative mode IMS. In embodiments the analytical apparatus comprises both a positive mode IMS and a negative mode IMS configured to analyse samples from a single sampling volume. In some embodiments a single IMS may be switchable between positive and negative modes and may be configured to rapidly switch between positive and negative modes in order to analyse a single sample in both the positive and negative modes.

The controller may be configured to receive an indication from the analytical apparatus that a substance of interest is detected, or is not detected, and to provide an indication to a user, such as to provide an alert to a user that a substance of interest is detected.

In some embodiments, operating parameters of the analytical apparatus, and/or parameters for data analysis, may be selected based on the timing of the sampling. For example, vapour sampling and aerosol sampling may be intended to detect different substances of interest, and operating parameters of an analytical apparatus such as a spectrometer may be controlled to enable or improve detection of a targeted substance. For example, depending on whether it is intended to detect vapours of interest or vaporised aerosols of interest that result in one or more specific peaks in a spectrum, operating parameters of a spectrometer or analysis of resulting data may be controlled to focus on the relevant peaks, and/or to exclude areas of a spectrum that are not relevant to expected substances of interest. Thus, operating parameters of the analytical apparatus may be selected independently for sampling vapours (for example in the first flow of air) and for sampling aerosols (for example in the second flow of air).

A further aspect provides a method for controlling power consumption in a detection apparatus for analysing vapours and aerosols, the method comprising the sequence of: (i) drawing a first flow of air through an inlet of the apparatus; (ii) sampling the first flow of air to detect a vapour of interest present in the first flow of air; (iii) reducing a flow rate of the air being drawn through the inlet to reduce cooling of a heater disposed in the inlet; (iv) increasing power to the heater to bring the heater to a temperature for vaporising aerosols in the inlet; (v) drawing a second flow of air through the inlet past the heater to carry vaporised aerosols for sampling; and (vi) sampling the vaporised aerosols to detect an aerosol present in the second flow of air.

The first flow of air may be drawn through the inlet with a first flow rate, and the second flow of air drawn through the inlet with a second flow rate. As will be appreciated, the first flow and second flow refer to portions of flow through the same inlet, for example flows provided at different times through the same inlet.

The first flow rate may be higher than the second flow rate. For example, the first flow rate may be drawn through the inlet for vapour sampling, and the flow rate reduced before increasing power to the heater, and the second flow rate maintained at the reduced flow rate or higher than the reduced flow rate but lower than the first flow rate.

Thus, in some embodiments, the second flow rate corresponds to the reduced flow rate provided at step (iii).

The second flow rate may be higher than the reduced flow rate provided at step (iii), for example wherein the second flow rate corresponds substantially to the first flow rate. In embodiments where the second flow rate corresponds to the first flow rate, operation of a flow provider may be simplified in that it can be operated with two flow rates, a flow rate for moving air through the inlet to provide vapours for sampling by the analytical apparatus, and a reduced flow rate.

Sampling the first and second flows of air may comprise drawing samples into one or more sampling ports of an analytical apparatus. As described previously, the one or more sampling ports may be selected from a pinhole inlet, a capillary inlet or a membrane inlet, preferably a pinhole inlet. The samples may be drawn through the one or more sampling ports by any suitable sampler, for example a sampler configured to reduce pressure on the downstream side of a sampling port to draw a volume of air through the sampling port.

Sampling of vapours in the inlet through the one or more sampling ports to the analytical apparatus may be timed based on when the heater is turned on and/or when the second flow is provided through the inlet. For example, sampling vaporised aerosols through the one or more sampling ports may be performed a fixed time period after increasing power to the heater and/or after increasing a flow through the inlet to provide the second flow of air past the heater to the one or more sampling ports.

The second flow of air may be heated to a temperature of at least 150° C. to vaporise aerosols, for example at least 200° C. The temperature may also be controlled to save power and avoid over-heating the inlet. Thus, the second flow of air may be heated to a temperature of no more than 300° C., for example no more than 250° C. The second flow of air may therefore be heated to a temperature of from 150° C. to 300° C., for example from 200° C. to 250° C.

The flow velocity and/or rate of the first and/or second flows of air may suitably be as described previously. For example, the first and/or the second flow of air may have a flow velocity past the heater of at least 0.4 m/s, such as at least 0.6 m/s, and the reduced flow rate may have a flow velocity of less than 0.4 m/s, such as less than 0.3 m/s.

It will be appreciated that the detector referred to in relation to the methods may comprise a detector or inlet apparatus as described elsewhere herein, and the method may comprise controlling the detector or inlet apparatus as described previously herein. For example, the method may comprise operation of a detector or inlet apparatus with a controller as described herein. For example, the methods may be implemented by the controller according to instructions stored in a memory of the controller.

The controller described herein may suitably be provided by any appropriate control logic, such as analogue control circuitry and/or digital processors, examples include field programmable gate arrays, FPGA, application specific integrated circuits, ASIC, a digital signal processor, DSP, or by software loaded into a programmable processor. Aspects of the disclosure comprise computer program products, and may be recorded on non-transitory computer readable media, and these may be operable to program a processor to perform any one or more of the methods described herein.

A further aspect provides a computer program product configured to program a controller of a detection apparatus to perform any of the methods described herein, or fixed logic circuitry configured to control a detection apparatus to perform any of the methods described herein.

### BRIEF DESCRIPTION OF FIGURES

Examples of the disclosure will now be described, by way of example only, with reference to the accompanying drawings, in which:

FIG. 1 shows a schematic illustration of a detector comprising an ion mobility spectrometer coupled to a detector inlet an inlet apparatus;

FIG. 2 shows a schematic illustration of detector inlet comprising an analytical apparatus including two spectrometers coupled to a detector inlet;

FIG. 3 shows the results of varying flow rates and heater power in a detector inlet; and

FIG. 4 illustrates a method of for controlling power consumption in a detection apparatus.

In the drawings like reference numerals are used to indicate like elements.

### SPECIFIC DESCRIPTION

The present disclosure relates to detector inlets comprising a heater for vaporising aerosols and reducing the power requirements of the heater.

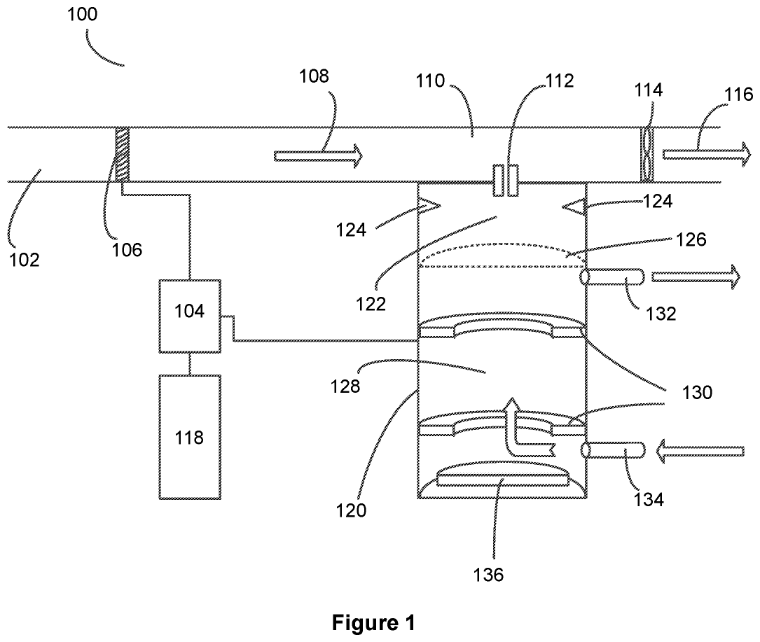

FIG. 1 shows a detection apparatus 100 comprising detector inlet 102 and an analytical apparatus comprising a spectrometer 120 having a sampling port 112 for obtaining samples for analysis from a sampling volume 110 into the spectrometer 120. The inlet comprises a heater 106 arranged in the path of air passing through the inlet 102. Downstream of the heater 106 the inlet 102 comprises a sampling port 112 provided by a pinhole. The inlet 102 comprises a flow passage configured to provide a flow of air drawn by a flow provider 114 from an ambient atmosphere outside the detector through the inlet 102 past the heater 106, then past the sampling port 112 to an exhaust 116. The heater 106 is configured to heat the flow through the inlet in order to vaporise aerosols in the flow passing the heater 106. A flow comprising vaporised aerosols 108 may then be drawn through the inlet by the flow provider 114. The flow comprising vaporised aerosols 108 passes through a sampling volume 110 adjacent the sampling port 112, so that the analytical apparatus 120 can obtain samples from the flow comprising vaporised aerosols 108.

The inlet apparatus comprises a controller 104 configured to control the heater 106 and the flow provider 114. The controller 104 is configured to control the flow provider 114 to reduce the flow rate through the inlet 102 past the heater 106, which reduces cooling of the heater 106 by the passing flow. The controller 104 increases power to the heater 106 after the flow rate is reduced to vaporise aerosols in the inlet 102. The vaporised aerosols are then carried in flow 108 to the sampling volume 110, and the controller controls the analytical apparatus 120 to obtain samples from the sampling volume through the sampling port 112. The flow carrying the vaporised aerosols 108 is provided by the flow provider 114. The flow provider 114 may, for example, increase the flow rate through the inlet after the heater 106 has been heated to the desired temperature in order to draw a flow of air past the heater 106 to the sampling volume 110.

The apparatus 100 may be configured for sampling vapours present in the flow drawn into the inlet 102 as well as aerosols. For example, the controller 104 may operate the apparatus so that a first flow of air is drawn into the inlet 102 when the heater 106 is off. The first flow, provided by the flow provider 114, flows past the heater 106 to the sampling volume 110. The controller 104 then controls the analytical apparatus 120 to draw a sample comprising vapours to be analysed in the first flow from the sampling volume 110 into the analytical apparatus 120 for analysis. The controller 104 then reduces the flow rate of the air through the inlet 102 in order to reduce the cooling effect of air passing the heater 106 before increasing power to the heater 106 to bring the heater to the required temperature. The flow provider 114 is controlled to provide a second flow of air through the inlet 102 past the powered heater 106 to vaporise aerosols in the second flow of air. The flow provider 114 may increase the flow in order to carry vaporised aerosols to the sampling volume 110 for sampling, or, where the reduced flow is sufficient, the reduced flow may carry vaporised aerosols to the sampling volume for analysis by the analytical apparatus.

The apparatus 100 may be portable, for example a handheld detector, and may comprise a portable power source 118 that can be carried by the detector. A portable power source may comprise a battery, a fuel cell, a capacitor, or any other portable source of electrical power suitable for providing electrical power to the detector. While the portable power source 118 is shown as connected to the controller 104, it will be appreciated that the portable power source may provide power to any of the components of the detection apparatus 100.

In FIG. 1, the spectrometer 120 comprises an ion mobility spectrometer which is coupled to the sampling volume 110 by the sampling port 112 and comprises a reaction region 122 in which a sample can be ionised. The sampling port 112 can be used to provide a sample from the sampling volume 110 into the spectrometer 120. A gate electrode 126 may separate the reaction region 122 from a drift chamber 128. The drift chamber 128 comprises a collector 136 toward the opposite end of the drift chamber 128 from the gate electrode 126. In other embodiments, an ion mobility spectrometer may be operated with an ion trap holding and releasing sample ions in place of the gate electrode 126. The drift chamber 128 also comprises a drift gas inlet 134, and a drift gas outlet 132 arranged to provide a flow of drift gas along the drift chamber 128 against the direction of movement of sample ions towards the collector 136, for example a drift gas flow is provided from the collector 136 towards the gate 126. The sampling port 112 can be used to sample air from the sampling volume 110 into the reaction region 122 of the spectrometer 120. The reaction region 122 comprises an ioniser 124 for ionising a sample. In the example shown in FIG. 1 the ioniser 124 comprises a corona discharge ioniser comprising electrodes, although it will be appreciated that other ionisation sources may be used. The drift chamber 128 also comprises drift electrodes 130 for applying an electric field along the drift chamber 128 to accelerate ions towards the collector 136 against the flow of the drift gas. The detector may comprise a sampler (not shown) configured to draw a selected volume of fluid, smaller than the sampling volume 110, through the sampling port 112 to provide a sample to the analytical apparatus. The sampler may comprise an electromechanical actuator, for example a solenoid driven actuator, and/or a mechanical pump arranged to transfer vapour from the sampling volume 110 through the sampling port 112 and into the analytical apparatus/spectrometer 120.

The apparatus 100 comprises a flow provider 114 for drawing air through the inlet 102 and past the heater 106 and the one or more sampling ports 112 of the analytical apparatus.

The flow provider 114 as shown in FIG. 1 provides an exhaust flow 116 downstream of the sampling volume 110 and sampling ports 112. The flow provider 114 may for example be provided by a pump, or a fan or any device suitable for drawing a flow of air through the inlet past the heater 106 to the sampling volume 110. The flow provider 114 itself may in some instances not be part of the detector and may be provided separately, and may for example be connectable to the inlet 102 in order to provide a flow through the inlet 102.

The apparatus 100, as shown in FIG. 1, comprises a controller 104 configured to control operation of the apparatus. For example, the controller may be coupled to, for example to control or to electronically communicate with, the heater 106, the analytical apparatus such as spectrometer 120 and the flow provider 114. The controller 104 may comprise a processor and a memory storing instructions for operation of the apparatus 100.

The controller 104 may be configured to operate the apparatus 100 in response to an activation signal, which may be provided by a user or an automated activation signal, such as a signal provided according to a pre-configured timing (e.g. intermittently at a fixed frequency).

The controller 104 may be configured to control the heat output of the heater 106 to vary the temperature and/or timing of the heating. The controller 104 may in some examples be configured to control the heater 106 and flow provider 114 to desorb residues which may have accumulated in the inlet 102 or on the heater 106. For example, the controller 104 may be configured to activate the heater 106 for a first time period and to draw air through the inlet 102 to enable substances desorbed from the inlet 102 to leave the inlet via the exhaust flow 116. In some instances, the desorption of substances in the inlet may be combined with vaporisation of aerosols for sampling. For example, the flow through the inlet 102 may be reduced as described and the heater 106 powered, followed by the first time period of providing flow through the inlet 102 and permitting desorbed substances to leave the inlet. Then after the first time period has elapsed, whilst the flow provider 114 continues to draw air though the inlet 102 past the heater 106, the air drawn past the heater 106 is heated to vaporise aerosols in the air for sampling by the analytical apparatus/spectrometer 120. Thus, the flow through the inlet 102 can flush desorbed substances out of the detector in preparation for testing a sample of air for aerosols. The heat output of the heater 106 during sampling of the second flow of air to vaporise aerosols may be less than the heat output during the first time period to desorb residues. For example, the heater 106 may be controlled to reduce power provided to the heater 106, for example by switching it off, after the first time period and the second flow of air heated at a lower power or while the heater is cooling.

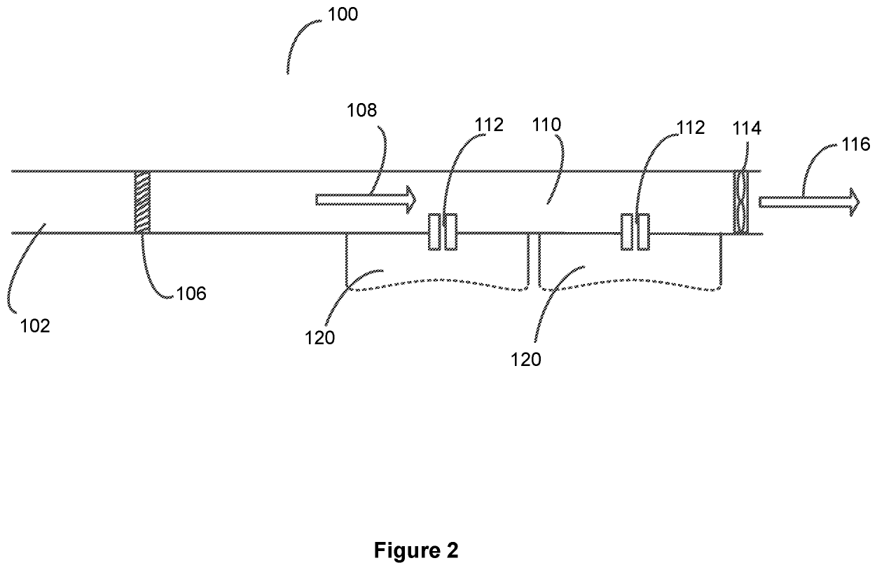

As shown in FIGS. 1 and 2 the inlet 102 comprises a flow passage arranged to receive a flow of air from an opening (not shown) for receiving air from the ambient atmosphere outside the apparatus 100. The inlet 102 is illustrated as being provided by a conduit, such as a hose or pipe. However, the inlet 102 may also be provided by channels, and plenums, which are cut into a block of material, and then enclosed. In the examples illustrated in FIGS. 1 and 2, the inlet may be less than 20 mm wide. For example, less than 10 mm wide, for example less than 5 mm, for example less than 2 mm, for example less than 1.5 mm, for example less than 1 mm, for example less than 0.75 mm, for example less than 0.5 mm, for example less than 0.4 mm, for example less than 0.3 mm, for example less than 0.2 mm, for example less than 0.1 mm. In the Examples illustrated in FIGS. 1 and 2, the inlet 102 may be at least 10 microns wide, for example at least 0.1 mm wide. For example, at least 0.2 mm, for example at least 0.3 mm, for example at least 0.4 mm, for example at least 0.5 mm, for example at least 0.75 mm, for example at least 1 mm, for example at least 1.5 mm, for example at least 2 mm, for example at least 5 mm wide.

As shown in FIGS. 1 and 2, the apparatus 100 may be configured so that the flow provider 114 draws a flow of air to be sampled past one or more sampling ports 112 of the analytical apparatus to permit sampling of vapour in the flow whilst drawing particulates present in the flow past the one or more sampling ports 112 without entering the one or more sampling ports 112. As shown schematically in FIGS. 1 and 2, sampling ports 112 are configured to draw samples into the analytical apparatus in an orthogonal direction to the direction of bulk flow through the sampling volume 110 to the exhaust 116 to reduce particulates entering or blocking the one or more sampling ports 112.

While FIG. 1 depicts an ion mobility spectrometer, the analytical apparatus may comprise any suitable apparatus for analysing vapours and vaporised aerosols. The analytical apparatus may for example comprise at least one of an ion mobility spectrometer (IMS), a differential mobility spectrometer (DMS), a mass spectrometer (MS), a chromatography apparatus (for example a gas chromatography system) and an optical spectrometer (for example an infrared spectrometer or a Raman spectrometer).

FIG. 2 shows an apparatus 100 as shown in FIG. 1, where the analytical apparatus comprises two spectrometers 120 having two respective pinhole sampling ports 112. The two spectrometers 120 may, for example, comprise a positive mode IMS and a negative mode IMS. Where the analytical apparatus comprises more than one separate analytical instrument, e.g. spectrometer, these may be the same or different in structure and/or operation. For example, both may be IMS instruments configured to operate differently, such as in positive and negative modes, or the two instruments may be different instruments such as an IMS and a mass spectrometer.

While the two sampling ports 112 are illustrated in FIG. 2 as being separated along the bulk flow direction through the inlet 102 to the exhaust 116, any suitable arrangement may be used depending on the requirements and internal structure of the apparatus 100. For example, the two sampling ports 112 (and in embodiments respective spectrometers 120) may be separated around the periphery or circumference of a flow passage comprising the sampling volume 110, for example the sampling ports 112 may each be substantially the same distance from the heater 106 such as disposed at opposing sides the flow passage or disposed adjacent to each other on a wall of the inlet and separated in a direction perpendicular to the bulk flow direction. While not shown in FIG. 2 for clarity, it will be appreciated that the controller 104 and portable power source 118 and other elements of FIG. 1 may be present, and the controller 104 may be coupled to and control operation of both spectrometers 120 in FIG. 2.

Whilst the apparatuses shown in FIGS. 1 and 2 provide embodiments of the present disclosure, other embodiments are contemplated.

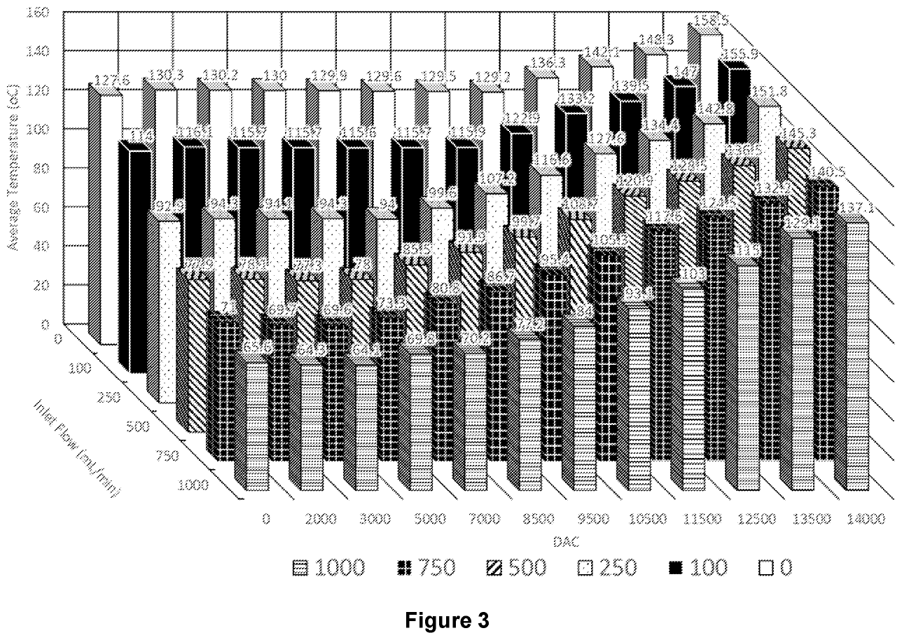

FIG. 3 shows the results of experiments measuring the temperature of a heater disposed in a detector inlet as described herein at different power levels and at different flow rates through the inlet. The heater comprised two heating elements comprising arrays of resistively heated elongate wires arranged across the inlet and separated in the direction of flow through the inlet. The temperature of the first upstream heater (at the opening of the inlet to the external atmosphere) was measured using a thermal camera directed at the inlet. The temperature was measured as an average temperature across a fixed square area at the cross-sectional centre of the heater in the inlet. It should be noted that the temperatures shown in FIG. 3 correspond to the temperature of the front of the first heater element and so the temperature of the air passing through the heater will be heated to a higher temperature than is shown in FIG. 3.

The flow through the inlet past the heater was measured and varied using a mass flow controller and was varied from 0 ml/min to 1000 ml/min (which corresponds to a flow velocity of 0.85 m/s). At each flow rate, the power provided to the heater was varied from a lowest power (DAC 0 in FIG. 3) to a highest power (DAC 14000 in FIG. 3). In FIG. 3, the flow rates are also shown by different patterns of the columns in the graph as shown in the key of the graph.

The “DAC” number shown in FIG. 3 corresponds to a relative power provided to the heater controlled by a parameter of a digital analogue converter, in respect of which DAC 0 corresponds to approximately 7.5 W.

As shown in FIG. 3, for a constant power applied to the heater, the average temperature of the heater may be increased by reducing the flow past the heater. Similarly, by reducing the flow past the heater, a lower power is required in order to reach a given heater temperature. As shown in FIG. 3, the effect of reducing flow through the inlet on the heater temperature is surprisingly particularly significant at lower relative power levels. Therefore, by reducing the flow through the inlet before providing power to the heater in the inlet as described herein, substantial power savings may be made for heating aerosols in the inlet of a detector.

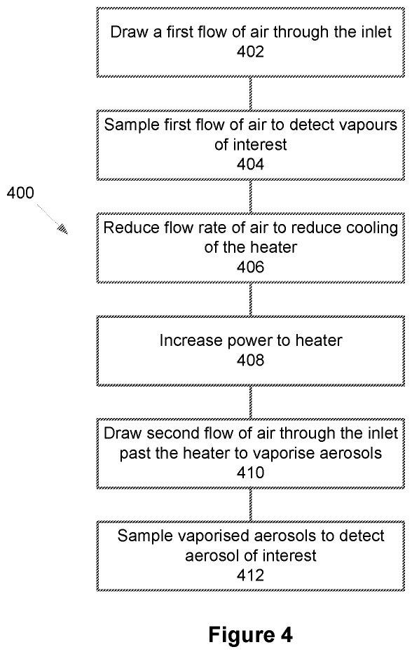

FIG. 4 illustrates a method 400 of controlling power consumption in a detection apparatus for analysing vapours and aerosols. As shown in FIG. 4, the method comprises 402 drawing a first flow of air through the inlet. The flow of air may suitably be drawn into the inlet through an opening in fluid communication with the ambient atmosphere external to the detector, past a heater disposed in the inlet, past one or more sampling ports of an analytical apparatus, and to an exhaust port. While the heater is off, the first flow of air can flow through the inlet past the heater and past the one or more sampling ports downstream of the heater. At step 404, vapours in the first flow of air may be sampled for analysis via the one or more sampling ports, and the analytical apparatus can be operated to analyse the vapours to detect substances of interest. Analysing the vapours may comprise ionising the vapours and analysing the resultant ions in an IMS as described previously herein, although any other suitable analysis technique may alternatively or additionally be performed.

At step 406, after vapours in the sampled ambient atmosphere have been drawn into the inlet with the first flow of air for analysis, the flow rate through the inlet is reduced to reduce the cooling effect of the flow on the heater. While the flow is reduced, at step 408 power to the heater is increased in order to increase the temperature of the heater for vaporising aerosols. Aerosols in the vicinity of the heater when the power is increased may be vaporised to provide vaporised aerosols. At step 410, a second flow of air is drawn through the inlet. The second flow may comprise aerosols drawn into the inlet from the ambient atmosphere which are vaporised by the heater as they flow past the heater. The second flow of air may also transport aerosols vaporised in the inlet when the heater was turned on to the one or more sampling ports for sampling. As described previously herein, the second flow may comprise an increased flow rate compared to the reduced flow rate, for example raising the flow rate to correspond to the rate of flow of the first flow. Alternatively, where it is sufficient to carry vaporised aerosols to the one or more sampling ports, the flow rate of the second flow of air through the inlet may remain at the reduced flow rate.

At step 412, the vaporised aerosols may be sampled for analysis via the one or more sampling ports, and the analytical apparatus can be operated to analyse the vaporised aerosols to detect substances of interest. As described herein, the timing of the sampling of aerosols may be varied relative to the timing of the heating and providing the second flow in order to sample vaporised aerosols that are drawn past the heater after it has been heated to temperature, or to sample aerosols vaporised during the step of increasing power to the heater while the flow is reduced. The analysis of the vaporised aerosols may in some instances differ to the analysis of the vapours sampled in step 404. For example, detection parameters of an analytical apparatus (such as detection windows and thresholds) may be selected independently for vapours sampled in step 404 and vaporised aerosols sampled in step 412. In this way, the analysis may be optimised for detecting substances of interest that are expected to be in vapour or aerosol form in the ambient atmosphere.

It will be appreciated that the detector inlet apparatus and the components thereof referred to in relation to the methods may comprise an apparatus 100, for example as shown in FIGS. 1 and 2, and the method may comprise controlling the apparatus 100 as described previously herein. For example, the method may comprise operation of an apparatus 100 with a controller 104 as described herein. For example, the methods may be implemented by the controller 104 according to instructions (e.g. software) stored in a memory of the controller 104. In some examples, the methods may be performed by fixed control logic configured to control the apparatus. Thus, the methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Although embodiments of the disclosure have been described as having particular application in ion mobility spectrometers, the apparatus and methods described may be applied in other analysis systems where there is a need to test for vapours such as vapours associated with aerosols having a low vapour pressure.

As will be appreciated a vapour may comprise a substance in its gaseous phase at a temperature lower than its critical point. By contrast with a vapour or gas, an aerosol comprises fine particles of solid or liquid suspended in a gas. As used herein, the term “vaporise” is used to mean converting at least some of a substance from a solid or liquid to a vapour or a gas.

In general, apparatus features described herein may be provided as method features, and vice versa.

It should also be appreciated that particular combinations of the various features described and defined in any aspects of the invention can be implemented and/or supplied and/or used independently. Other examples and variations will be apparent to the skilled addressee in the context of the present disclosure.

1. An inlet apparatus for a detection system, the apparatus comprising:
an inlet for receiving a flow of air to be tested, the inlet comprising a heater configured to heat the flow of air to vaporise an aerosol carried by the air for sampling by the analytical apparatus;
a flow provider configured to draw the flow of air through the inlet past the heater for sampling by the analytical apparatus; and
a controller configured to control operation of the heater and the flow provider to reduce a flow rate of the air past the heater to reduce cooling of the heater before increasing power to the heater to vaporise aerosols, and to control the flow provider to provide aerosols vaporised by the heater for sampling by the analytical apparatus.

2. The apparatus of claim 1, wherein the controller is configured to operate the apparatus for detecting vapours and aerosols by drawing a first flow of air into the inlet when the heater is off and providing the first flow of air for sampling by the analytical apparatus before reducing the flow rate of the air past the heater.

3. The apparatus of any one of the preceding claims, wherein after increasing power to the heater while the flow rate is reduced, the controller is configured to control the apparatus to draw a second flow of air into the inlet past the heater to vaporise aerosols in the second flow of air and to provide the vaporised aerosols for sampling by the analytical apparatus.

4. The apparatus of any one of the preceding claims, wherein providing the vaporised aerosols for sampling by the analytical apparatus comprises operating the flow provider to increase the flow rate through the inlet.

5. The apparatus of any one of claims 1 to 3, wherein reducing a flow rate of the air past the heater comprises providing a reduced flow rate, and providing the vaporised aerosols for sampling by the analytical apparatus comprises maintaining the reduced flow rate to transport the vaporised aerosols from the heater to the analytical apparatus.

6. The apparatus of any one claims 1 to 4, wherein reducing a flow rate of the air past the heater comprises stopping the flow provider from providing flow through the inlet.

7. The apparatus of any one of the preceding claims, wherein the controller is configured to operate the flow provider to provide the vaporised aerosols to the analytical apparatus after the heater reaches a threshold temperature and/or after a fixed time delay after the heater is turned on.

8. The apparatus of any one of the preceding claims, wherein the flow velocity through the inlet past the heater prior to reducing the flow rate is at least 0.4 m/s and/or wherein the flow velocity through the inlet past the heater when the heater is turned on is less than 0.4 m/s, for example wherein the flow velocity through the inlet past the heater prior to reducing the flow rate is at least 0.6 m/s and/or wherein the flow velocity through the inlet past the heater when the heater is turned on is less than 0.3 m/s.

9. The apparatus of any one of the preceding claims, wherein the heater comprises wire arranged in the inlet in the path of the flow of air so that the flow of air must pass the wire to reach the analytical apparatus.

10. The apparatus of any one of the preceding claims, wherein the heater is configured to heat the flow of air to a temperature of at least 150° C. to vaporise aerosols, for example at least 200° C., and/or wherein the heater is configured to heat the flow of air to a temperature of no more than 300° C., for example no more than 250° C.

11. The apparatus of any one of the preceding claims, wherein the inlet comprises one or more sampling ports through which the analytical apparatus is configured to obtain samples from the inlet, for example one or more sampling ports selected from a pinhole inlet, a capillary inlet or a membrane inlet.

12. The apparatus of claim 11, wherein the apparatus is configured to provide a flow of air through the inlet past the heater and then past the one or more sampling ports.

13. The apparatus of claim 12, wherein the flow provider is configured to draw the flow to be sampled past the one or more sampling ports of the analytical apparatus to permit sampling of vapour in the flow whilst drawing particulates present in the flow past the one or more sampling ports without entering the one or more sampling ports.

14. A detector comprising the inlet apparatus of any one of the preceding claims and an analytical apparatus configured to obtain samples from the inlet for detecting a substance of interest.

15. The detector of claim 14, wherein the controller is configured to synchronise operation of analytical apparatus with operation of the flow provider and/or the heater to obtain samples of the vaporised aerosol provided from the heater to the analytical apparatus by the flow provider.

16. The detector of claim 14 or 15, wherein the detector is a portable detector comprising a portable power supply, for example a hand-held detector.

17. The detector of any one of claims 14 to 16, wherein the detector is configured to draw the flow of air from an ambient environment in which the detector is situated.

18. The detector of any one of claims 14 to 17, wherein the analytical apparatus comprises at least one of an ion mobility spectrometer, a differential mobility spectrometer, a mass spectrometer, a chromatography apparatus or an optical spectrometer.

19. A method for controlling power consumption in a detection apparatus for analysing vapours and aerosols, the method comprising the sequence of:
(i) drawing a first flow of air through an inlet of the apparatus;
(ii) sampling the first flow of air to detect a vapour of interest present in the first flow of air;
(iii) reducing a flow rate of the air being drawn through the inlet to reduce cooling of a heater disposed in the inlet;
(iv) increasing power to the heater to bring the heater to a temperature for vaporising aerosols in the inlet;
(v) drawing a second flow of air through the inlet past the heater to carry vaporised aerosols for sampling; and
(vi) sampling the vaporised aerosols to detect an aerosol present in the second flow of air.

20. The method of claim 19, wherein the first flow of air is drawn through the inlet with a first flow rate, the second flow of air is drawn through the inlet with a second flow rate.

21. The method of claim 20, wherein the first flow rate is higher than the second flow rate.

22. The method of claim 21, wherein the second flow rate corresponds to the reduced flow rate provided at step (iii).

23. The method of claim 20 or claim 21, wherein the second flow rate is higher than the reduced flow rate provided at step (iii), for example wherein the second flow rate corresponds substantially to the first flow rate.

24. The method of any one of claims 19 to 23, wherein sampling the first and second flows of air comprises drawing samples into one or more sampling ports of an analytical apparatus, for example one or more sampling ports selected from a pinhole inlet, a capillary inlet or a membrane inlet.

25. The method of any one of claims 19 to 24, comprising heating the second flow of air to a temperature of at least 150° C. to vaporise aerosols, for example at least 200° C., and/or heating the second flow of air to a temperature of no more than 300° C., for example no more than 250° C.

26. The method of any one of claims 19 to 25, wherein the first and/or the second flow of air has a flow velocity past the heater of at least 0.4 m/s, and the reduced flow rate has a flow velocity of less than 0.4 m/s.

27. A computer program product configured to program a controller of a detection apparatus to perform the method of any one of claims 19 to 26, or fixed logic circuitry configured to control a detection apparatus to perform the method of any one of claims 19 to 26.
